(19) United States
(12) Patent Application Publication
(10) Pub. No.: US 2026/0273780 A1
(43) Pub. Date: Sep. 17, 2026

(54) DYNAMICALLY STABLE WHEELED ROBOT AND RELATED TECHNOLOGY

(71) Applicant: Agility Robotics, Inc., Pittsburgh, PA (US)

(72) Inventors: Jonathan Hurst, Albany, OR (US); Prasanna Velagapudi, Pittsburgh, PA (US)

(21) Appl. No.: 19/564,061

(22) Filed: Mar. 11, 2026

Related U.S. Application Data
(60) Provisional application No. 63/770,780, filed on Mar. 12, 2025.

(51) Int. Cl. B25J 19/00; B25J 5/00; B25J 9/16

(52) U.S. Cl. CPC B25J 19/0008; B25J 5/007; B25J 9/1638

(57) ABSTRACT

A mobile robot includes a wheel and a plurality of additional wheels configured to contact a ground surface, with a support carried by the wheels. A wheel-to-support connector movably connects the wheel to the support, with first and second actuators configured to cause relative rotation between the wheel and the support about different first and second axes. A body is carried by the support and movably connected thereto through a body-to-support connector. Third and fourth actuators are configured to cause relative rotation between the body and the support about different third and fourth axes. An arm carried by the body enables object manipulation. The mobile robot has statically stable and dynamically stable operational states. A controller causes the mobile robot to maintain dynamic stability in the dynamically stable operational state via coordinated operation of at least the first, second, third, and fourth actuators.

### CROSS-REFERENCE TO RELATED APPLICATION

This claims the benefit of U.S. Provisional Application No. 63/770,780, filed Mar. 12, 2025. The foregoing application is incorporated herein by reference in its entirety. To the extent the foregoing application or any other material incorporated by reference conflicts with the present disclosure, the present disclosure controls.

### FIELD

The present technology relates to a dynamically stable wheel mechanism and system suitable for robotic applications, including those with humanoid form factors.

### BACKGROUND

Robotic automation presents a compelling solution for many tasks currently performed by human workers. In particular, order-fulfillment centers and warehouses employ millions of workers primarily to execute repetitive movements of items and containers—tasks ideally suited for automation. Human cognitive capabilities are more effectively deployed toward complex endeavors requiring creativity, advanced problem solving, and interpersonal engagement. The demand for order-fulfillment functions continues to grow rapidly, with industry analysts projecting a shortage exceeding one million workers for these facilities within the next decade. Given the economic significance of this sector, even incremental efficiency improvements can generate substantial productivity gains at a macroeconomic level. These factors create an urgent and expanding need for technological innovations that enable the comprehensive automation of warehouse operations and similar logistical functions currently dependent on human labor.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a mobile robot assembly is provided. The mobile robot assembly includes a platform, a body, and a control system. The platform has a superior surface and an inferior surface. The superior surface supports a connecting joint connecting the platform to the body. The platform further has at least three wheels disposed on the inferior surface. The at least three wheels are configured to collaboratively move the platform. The body has at least one arm disposed thereon. The control system is disposed on the mobile robot assembly and has at least a connecting joint control authority and a wheel control authority.

According to other aspects of the present disclosure, the mobile robot assembly may include one or more of the following features. The body may further comprise at least two legs optionally detachable from the platform. The connecting joint may have at least two rotational degrees of freedom. Wheels disposed on the inferior surface of the platform may move in any direction. Wheels disposed on the inferior surface of the platform may be positionally arranged in at least one of a triangular, square, pentagonal, or hexagonal layout. At least one of the wheels disposed on the inferior surface of the platform may not be powered to move. The mobile robot assembly may further comprise a power supply disposed on the mobile robot assembly for powering at least the wheels, the connecting joint, and the control system. The joint control authority and the wheel control authority may jointly act to maintain a center of pressure within a perimeter defined by the at least three wheels disposed on the inferior surface of the platform. The body may present as humanoid.

According to another aspect of the present disclosure, a method of operating a mobile robot assembly is provided. The mobile robot assembly has a control system, a body, and a platform with at least some actuated wheels defining a stability zone. The body is disposed on the platform at an actuated connecting joint configured to pivot the body with at least two degrees of freedom about the connecting joint. The method includes moving the platform using the actuated wheels in a planar direction along a ground surface. The method includes monitoring, by the control system, a location of the center of gravity of the mobile robot assembly, and the resulting center of pressure of the platform. The method includes selectively adjusting, by the control system, the location of the center of pressure of the body by actuation of one or more of the connecting joint and the actuated wheels.

According to other aspects of the present disclosure, the method may include one or more of the following features. The wheels may be positionally arranged in at least one of a triangular, square, pentagonal, or hexagonal layout. At least one of the wheels may not be powered to move. All of the wheels may be powered to move. At least some of the actuated wheels may be omnidirectional. The method may further comprise a power supply disposed on the mobile robot assembly for powering at least the wheels, the connecting joint, and the control system.

According to another aspect of the present disclosure, a method of operating a mobile robot assembly is provided. The mobile robot assembly has a control system, a body, and a platform with at least some actuated wheels. The body is disposed on the platform at an actuated connecting joint configured to pivot the body with at least one degree of freedom about the connecting joint. The body further has an arm and at least one of a knee, waist, and neck joint. The method includes moving the platform using the actuated wheels in a planar direction along a ground surface. The method includes monitoring, by the control system, a location of the center of gravity of the mobile robot assembly, and the resulting center of pressure of the platform. The method includes selectively adjusting, by the control system, the location of the center of pressure of the body by actuation of one or more of the connecting joint, the actuated wheels, the arm, and knee, waist, or neck joints.

According to other aspects of the present disclosure, the method may include one or more of the following features. The wheels may be positionally arranged in at least one of a triangular, square, pentagonal, or hexagonal layout. At least one of the wheels may not be powered to move. All of the wheels may be powered to move. At least some of the actuated wheels may be omnidirectional.

According to another aspect of the present disclosure, a mobile robot is provided. The mobile robot includes a wheel configured to contact a ground surface. The mobile robot includes a plurality of additional wheels configured to contact the ground surface and spaced apart from the wheel. The mobile robot includes a support carried by the wheel and the plurality of additional wheels. The mobile robot includes a wheel-to-support connector through which the wheel is movably connected to the support. The mobile robot includes a first actuator and a second actuator configured to cause relative rotation between the wheel and the support about a first axis and a second axis, respectively, wherein the first and second axes are different from one another. The mobile robot includes a body carried by the support. The mobile robot includes a body-to-support connector through which the body is movably connected to the support. The mobile robot includes a third actuator and a fourth actuator configured to cause relative rotation between the body and the support about a third axis and a fourth axis, respectively, wherein the third and fourth axes are different from one another. The mobile robot includes an arm carried by the body, wherein the mobile robot is configured to manipulate objects via the arm. The mobile robot has a statically stable operational state in which the wheel and the plurality of additional wheels are in contact with the ground surface and in which the support is stationary relative to the ground surface. The mobile robot has a dynamically stable operational state in which the wheel and the plurality of additional wheels are in contact with the ground surface and in which the support is in motion relative to the ground surface. The mobile robot further comprises a controller including a processor and memory storing instructions that, when executed via the processor, cause the mobile robot to maintain dynamic stability in the dynamically stable operational state via coordinated operation of at least the first actuator, the second actuator, the third actuator, and the fourth actuator.

According to other aspects of the present disclosure, the mobile robot may include one or more of the following features. The second axis may be within 15 degrees of perpendicular to the first axis. The fourth axis may be within 15 degrees of perpendicular to the third axis. The mobile robot may define a height in a vertical dimension while the wheel and the plurality of additional wheels are in contact with a horizontal ground surface, and a total mass of the mobile robot above the body-to-support connector along the height may be greater than a total mass of the mobile robot below the body-to-support connector along the height. The body-to-support connector may be at a lowermost third of the mobile robot along the height. The mobile robot may further comprise a fifth actuator configured to cause relative rotation between the body and the support about a fifth axis different from the third and fourth axes. The fifth axis may be within 15 degrees of perpendicular to the fourth axis. The plurality of additional wheels may include three wheels configured to contact the ground surface, and the wheel and the plurality of additional wheels may be configured to define a rectangular support polygon of the mobile robot. The mobile robot may further comprise an inertial measurement system at the body, the controller may be configured to receive orientation information from the inertial measurement system, and the instructions, when executed via the processor, may cause the mobile robot to maintain dynamic stability in the dynamically stable operational state via coordinated operation of at least the first actuator, the second actuator, the third actuator, and the fourth actuator based at least partially on the orientation information. The instructions, when executed via the processor, may cause the mobile robot to operate the first actuator and the second actuator on a first timescale and to operate the third actuator and the fourth actuator on a second timescale different than the first timescale. The first timescale may be faster than the second timescale.

According to another aspect of the present disclosure, a mobile robot is provided. The mobile robot includes a first wheel configured to contact a horizontal ground surface at a first location while the mobile robot operates on the horizontal ground surface. The mobile robot includes a second wheel configured to contact the horizontal ground surface at a second location different than the first location while the mobile robot operates on the horizontal ground surface. The mobile robot includes a third wheel configured to contact the horizontal ground surface at a third location different than the first location and different than the second location while the mobile robot operates on the horizontal ground surface. The mobile robot includes a support carried by the first wheel, the second wheel, and the third wheel. The mobile robot includes a joint carried by the support. The mobile robot includes a body connected to the support via the joint. The mobile robot includes an arm carried by the body, wherein the mobile robot is configured to manipulate objects via the arm. The mobile robot includes a first actuator configured to drive rotation of the first wheel relative to the support about a first axis. The mobile robot includes a second actuator configured to drive rotation of the first wheel relative to the support about a second axis different than the first axis. The mobile robot includes a third actuator configured to drive rotation of the body relative to the support via the joint. The mobile robot includes a controller including a processor and memory storing instructions that, when executed via the processor, cause the mobile robot to maintain dynamic stability via coordinated operation of the first actuator, the second actuator, and the third actuator.

According to other aspects of the present disclosure, the mobile robot may include one or more of the following features. The joint may be a first joint, the third actuator may be configured to drive rotation of the body relative to the support via the first joint about a third axis, the mobile robot may further comprise a second joint carried by the support and a fourth actuator configured to drive rotation of the body relative to the support via the second joint about a fourth axis different than the third axis, and the body may be connected to the support via the second joint. The fourth axis may be within 15 degrees of perpendicular to the third axis. The mobile robot may define a height in a vertical dimension while the mobile robot operates on the horizontal ground surface, and a total mass of the mobile robot above the joint along the height may be greater than a total mass of the mobile robot below the joint along the height when the mobile robot operates on the horizontal ground surface. The joint may be at a lowermost third of the mobile robot along the height when the mobile robot operates on the horizontal ground surface. The first axis may be within 15 degrees of horizontal when the first wheel, the second wheel, and the third wheel are in contact with the horizontal ground surface. The second axis may be within 15 degrees of perpendicular to the first axis. The second axis may be within 15 degrees of horizontal when the first wheel, the second wheel, and the third wheel are in contact with the horizontal ground surface. The second axis may be within 15 degrees of vertical when the first wheel, the second wheel, and the third wheel are in contact with the horizontal ground surface. The mobile robot may further comprise an inertial measurement system at the body, the controller may be configured to receive orientation information from the inertial measurement system, and the instructions, when executed via the processor, may cause the mobile robot to maintain dynamic stability via coordinated operation of the first actuator, the second actuator, and the third actuator based at least partially on the orientation information. The second wheel and the third wheel may be omnidirectional. The second wheel and the third wheel may be nonactuated. The mobile robot may further comprise a fourth wheel configured to contact the horizontal ground surface at a fourth location different than the first location, different than the second location, and different than the third location while the mobile robot operates on the horizontal ground surface. The first wheel, the second wheel, the third wheel, and the fourth wheel may be configured to define a rectangular support polygon of the mobile robot while the mobile robot operates on the horizontal ground surface. The instructions, when executed via the processor, may cause the mobile robot to operate the first actuator and the second actuator on a first timescale and to operate the third actuator on a second timescale different than the first timescale. The first timescale may be faster than the second timescale.

According to another aspect of the present disclosure, a method is provided. The method includes causing rotation of a first wheel of a mobile robot relative to a support of the mobile robot about a first axis via a first actuator of the mobile robot while the support is carried by the first wheel, a second wheel, and a third wheel of the mobile robot. The method includes causing rotation of the first wheel relative to the support about a second axis via a second actuator of the mobile robot while the support is carried by the first wheel, the second wheel, and the third wheel. The method includes causing rotation of a body of the mobile robot relative to the support at a joint of the mobile robot via a third actuator of the mobile robot while the body is connected to the support via the joint. The method includes maintaining dynamic stability of the mobile robot via coordinated operation of the first actuator, the second actuator, and the third actuator.

According to other aspects of the present disclosure, the method may include one or more of the following features. The joint may be a first joint, causing rotation of the body relative to the support may include causing rotation of the body relative to the support via the first joint about a third axis, and the method may further comprise causing rotation of the body relative to the support via a second joint of the mobile robot about a fourth axis different than the third axis while the body is connected to the support via the second joint. Causing the rotation of the body relative to the support via the second joint about the fourth axis may include causing the rotation of the body relative to the support via the second joint about the fourth axis while the fourth axis is within 15 degrees of perpendicular to the third axis. During the method, the mobile robot may define a height in a vertical dimension, and a total mass of the mobile robot above the joint along the height may be greater than a total mass of the mobile robot below the joint along the height. During the method, the joint may be at a lowermost third of the mobile robot along the height. During the method, the second axis may be within 15 degrees of perpendicular to the first axis. Maintaining the dynamic stability of the mobile robot may include maintaining the dynamic stability of the mobile robot via coordinated operation of the first actuator, the second actuator, and the third actuator based at least partially on orientation information from an inertial measurement system of the mobile robot at the body. During the method, the first wheel, the second wheel, the third wheel, and a fourth wheel of the mobile robot may define a rectangular support polygon of the mobile robot.

The foregoing general description of the illustrative embodiments and the following detailed description thereof are merely aspects of the teachings of this disclosure and are not restrictive.

### BRIEF DESCRIPTION OF FIGURES

Certain aspects of the present technology can be better understood with reference to the following drawings. The relative dimensions in the drawings may be to scale with respect to some embodiments of the present technology. With respect to other embodiments, the drawings may not be to scale. For clarity, reference-number labels for analogous components or features may be omitted when the appropriate reference-number labels for such analogous components or features are clear in the context of the specification and all of the drawings considered together. Furthermore, the same reference numbers may be used to identify analogous components or features in multiple described embodiments.

FIG. 1A is a simplified view of a mobile robot assembly with a body and a connecting joint to a movable platform.

FIG. 1B is a simplified view of the mobile robot assembly of FIG. 1A with a body and a connecting joint leaning forward with respect to the movable platform.

FIG. 1C is a simplified view of a mobile robot assembly with a body and a connecting joint leaning backward and sideways with respect to the movable platform.

FIG. 2 illustrates aspects of determining center of pressure for a mobile robot assembly having a body and a connecting joint to a movable platform.

FIG. 3 illustrates a method of maintaining balance of a mobile robot assembly with a body using actuated wheels and movement of a connecting joint.

FIG. 4A illustrates a mobile robot assembly with humanoid legs replaced with an adjustable height column or pillar.

FIG. 4B illustrates a robot assembly with a single arm.

FIG. 5 is a block diagram illustrating an electrical and computer system of a mobile robot assembly such as illustrated in FIGS. 1, 4A, and 4B.

FIG. 6 is a partially schematic front profile view of a mobile robot in accordance with at least some embodiments of the present technology.

### DETAILED DESCRIPTION

The following description sets forth aspects of the present technology. It should be recognized, however, that such description is not intended as a limitation on the scope of the present technology. Rather, the description also encompasses combinations and modifications to those aspects described herein.

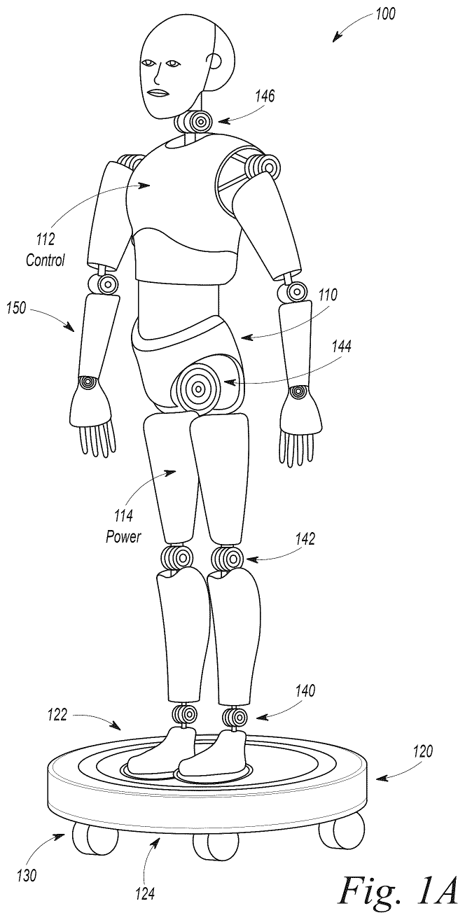

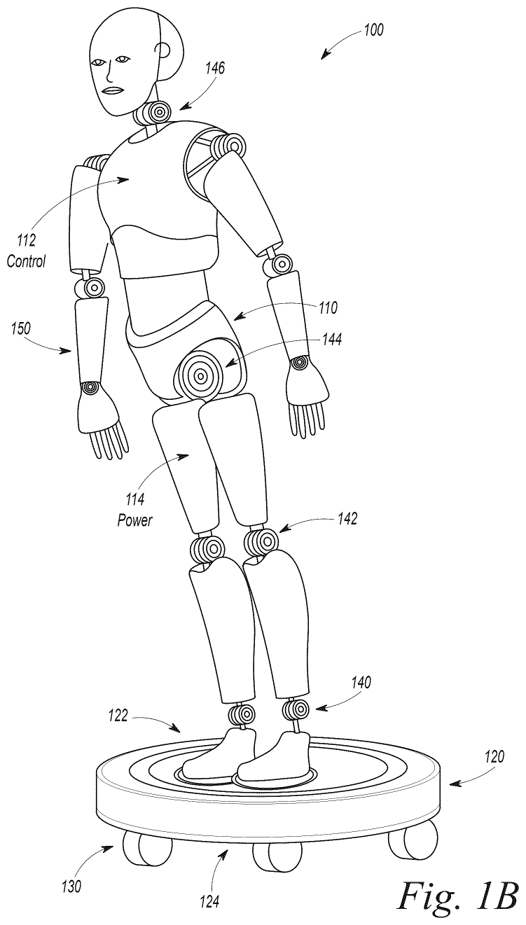

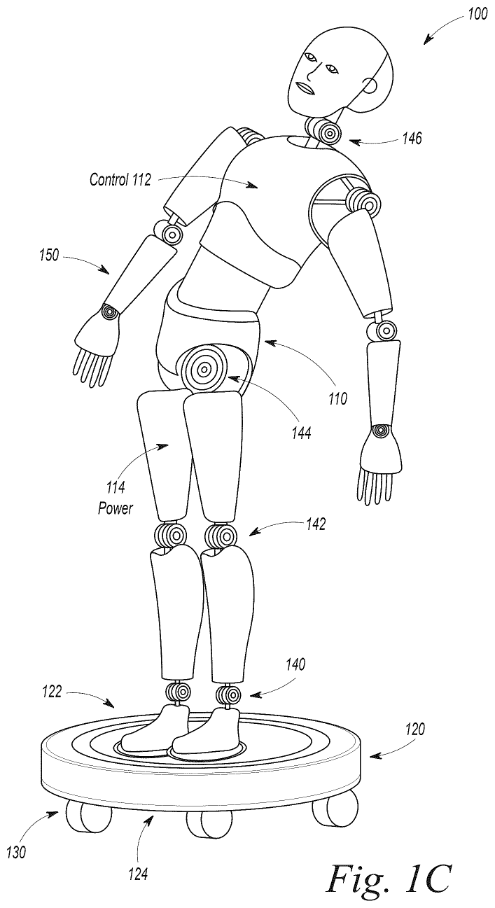

FIG. 1A is a simplified view of a mobile robot assembly 100 with a body 110 connected to a platform 120. The platform 120 has a superior surface 122 and an inferior surface 124, with the superior surface 122 supporting a connecting joint 140 connecting the platform 120 to the body 110. The platform 120 further has at least three wheels 130 disposed on the inferior surface 124. The wheels 130 are powered and actuated in a manner that allows them to collaboratively move the platform 120. The body 110 has at least one arm 150 attached or otherwise disposed on the body 110. In this embodiment, the robot assembly 100 can appear humanoid, supporting an arm 150, an ankle joint (i.e., connecting joint 140 connected to the platform 120 with both feet), knee joint 142, waist joint 144, and neck joint 146. A control system 112, disposed in the mobile robot assembly 100, has at least a connecting joint control authority and a wheel control authority. A power system 114 provides power for movement of the mobile robot assembly 100.

Possible movement positions of the mobile robot assembly 100 of FIG. 1A with respect to platform 120 are illustrated by FIG. 1B and FIG. 1C. FIG. 1B is a simplified view of the mobile robot assembly 100 of FIG. 1A with the body 110 and the connecting ankle/foot joint 140 leaning forward with respect to the movable platform. FIG. 1C is a simplified view of a mobile robot assembly with the body 110 and the connecting ankle/foot joint 140 leaning backward and sideways with respect to the movable platform 120. In FIG. 1C, waist joint may be used to enable the leaning. These and other movements of the mobile robot assembly 100 can be used to arrange the mobile robot assembly 100 to move into bodily poses that allow, for example, the mobile robot assembly 100 to maneuver into narrow spaces and hallways made for people, to reach top shelves, to reach the floor, and to pick up relatively heavy objects.

In some embodiments, the body 110 and other structures of the mobile robot assembly 100 can appear as humanoid or human-like, with structures resembling human anatomy with respect to the features, positions, or other characteristics of such structures. In at least some cases, the mobile robot assembly 100 defines a midsagittal plane about which it is bilaterally symmetrical. Counterparts of the mobile robot assembly 100 can have other suitable forms and features. For example, a counterpart of the mobile robot assembly 100 can have a non-humanoid form, such as a canine form, an insectoid form, an arachnoid form, or a form with no animal analog. Furthermore, a counterpart of the mobile robot assembly 100 can be asymmetrical or have symmetry other than bilateral.

As will be appreciated, in other embodiments the mobile robot assembly 100 can be implemented in the context of mobile robots with more than two arms and/or in the context of either non-legged or optionally-legged mobile robots. The described robots can be implemented in the context of moving objects such as totes, boxes, crates, non-packaged hard goods, irregularly shaped objects, etc.

In some embodiments, the platform 120 can be shaped to be generally cylindrical, to have a rectangular boxlike form, or to have ellipsoid or otherwise curved shapes. The platform 120 can include separate control and power systems or can be alternatively controlled and powered by control system 112 and power system 114, respectively, positioned within the body 110 of the mobile robot assembly 100.

In some embodiments, at least some of the wheels 130 disposed on the inferior surface 124 of the platform 120 can move in any direction (i.e., omnidirectionally). Three, four, five, six, or more wheels 130 can be attached to the platform, and the wheels 130 can be positionally arranged in at least one of a triangular, square, pentagonal, or hexagonal layout. In some embodiments the wheels can be attached at or near a perimeter of the platform 120. In some embodiments the wheels 130 are entirely arranged to fit on the inferior surface 124 of the platform 120, while in other embodiments one or more wheels can be attached to extend outward and away from the platform.

In some embodiments at least one of wheels 130 disposed on the inferior surface 124 of the platform 120 is not powered to move. For example, six wheels can be provided in a hexagonal layout, with only three wheels being powered. In other embodiments, omnidirectional wheels incorporating multiple smaller wheels mounted around a radius can be used. This allows active rolling on the omnidirectional wheel axis and still allows an ability to slide sideways using rolling of the smaller wheels. A set of at least three omnidirectional wheels, all pointing in different directions, can control the base to go in any direction or rotate in place. In another embodiment a swerve drive including powered wheels that can be oriented in any direction can be used. Swerve drive powered wheels can be mounted on a powered swivel or can include two motors mounted to a differential mechanism (so when rotating together, the wheel rolls). In such embodiments, when rotating at different speeds, the orientation of the wheel changes. Typically with a swerve drive, all of the wheels must point in the same direction for the base to move in that direction, or they must point to define a circular trajectory for the base to rotate. In one embodiment, for example, omnidirectional or swerve drive wheels, all actuated, can be arranged in a rectangular layout that allows for fast rotation and acceleration of the mobile robot assembly 100.

In some embodiments, one or more kinds of drive systems may be included on the mobile robot assembly 100. These drive systems (not shown), may be configured to drive and/or steer the wheels 130, under a control authority from control system 112. The wheels 130 may be driven symmetrically or asymmetrically, thereby providing the mobile robot assembly 100 with an ability to perform motion along any combination of linear and nonlinear paths (trajectories). Various kinds of drive systems may be implemented on the mobile robot assembly 100, including but not limited to swerve drive systems, Mecanum wheel systems, omniwheel systems, and so on.

In some embodiments the connecting joint 140 can have one, two, or three degrees of freedom. Joint types can include but are not limited to spherical joints, ball and socket joints, universal or cardan joints.

In some embodiments, the arm 150 can have various articulations such as a joint and a corresponding actuator, such as a rotary actuator with a motor and gearing (e.g., cycloidal gearing or strain-wave gearing). In an aspect, a rotary actuator(s) can be used to implement motion at one or more joints associated with mobile robot assembly 100. In at least some cases, the mobile robot assembly 100 is configured to manipulate objects via the arm 150. The arm 150 can separately extend from the body 110 and define kinematic chains. In at least some cases, the kinematic chains provide at least five degrees of freedom. The arm 150 can include end effectors at distalmost portions of the corresponding kinematic chains. Rotary joints may be used on one or more joints associated with end effectors.

As will be understood, the mobile robot assembly 100 can include various types of one, two, or three dimensional joints. These can include but are not limited to, telescoping, linear, or prismatic joints where one or both sides of a joint can move or extend with respect to each other. Other types of joints that permit movement of structures with respect to each other while potentially maintaining mechanical and electrical power connection can include spherical joints, ball and socket joints, universal or cardan joints, cylindrical joints, slider joints, or planar joints.

In operation, the mobile robot assembly 100 uses its control system 112 to manage a position of its body 110 and the platform 120 so that its actuated wheels 130 define a stability zone. To reduce tipping potential, the body 110 can be disposed on the platform 120 at the actuated connecting joint 140, and the mobile robot assembly 100 can further be configured to pivot the body 110 with at least two degrees of freedom about the connecting joint 140. The position and extent of the stability zone can be modified by accelerating the platform 120 using the actuated wheels (e.g., one or more of the wheels 130) in a planar direction along a ground surface (e.g., an X-Y coordinate plane defined by the ground surface). This operation involves monitoring, by the control system 112 and various connected sensors (not shown), a location of the center of gravity of the mobile robot assembly, and the resulting center of pressure of the platform. The control system 112 can selectively adjust the location of the center of pressure of the body 110 by actuation of one or more of the connecting joint 140 and the actuated wheels 130. In some embodiments, in addition or instead of movement of the connecting joint 140, the arm 150 or knee 142, waist 144, or neck 146 joints can be moved or otherwise actuated to adjust the center of gravity and center of pressure. In still other embodiments, movable weights or masses supported by the body 110 or platform 120 can be used to adjust the center of gravity and center of pressure.

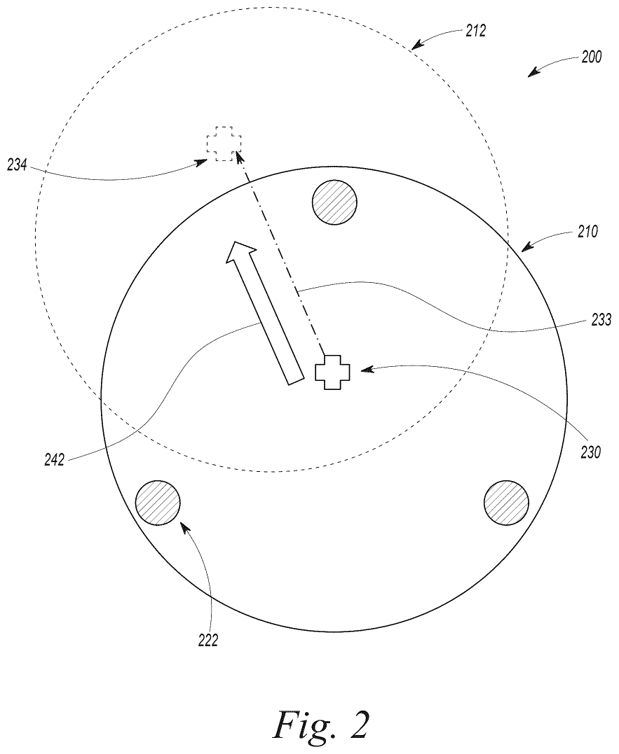

FIG. 2 illustrates aspects of determining and adjusting center of pressure for a robot having a movable body and a connecting joint to a movable platform (e.g., mobile robot assembly 100 illustrated in FIG. 1A-C). As illustrated by schematic 200 in a top down view of a cylindrical platform 210, the platform has three actuated and omnidirectional wheels 222 arranged in a triangular layout near a perimeter of the platform 210. Platform 210 may be similar to platform 120. Wheels 222 may be similar to wheels 130. A center of pressure 230 can initially be found centrally positioned within a stability zone of the platform 210. When the robot body is upright and its center of gravity is within the boundaries of the platform 210 there is little danger of tipping (i.e., a probability of the mobile robot assembly 100 tipping over is small). In other words, the mobile robot assembly 100 is in stable equilibrium, where there is no unbalanced moment that can tip the mobile robot assembly 100 over. If however, the robot body, the arm 150, or knee, waist, or neck joints bend forward in a direction 233 or act to lift weights using, for example, arm(s) 150, the center of pressure can change to position 234, increasing tipping potential. Essentially, the unbalanced center of pressure at position 234 causes a tipping moment (i.e., a mechanically unstable condition) that causes mobile robot assembly 100 to tip over. This mechanically unstable condition is caused by a tipping moment generated by a downward force vector associated with the center of pressure at position 234, and a normal reaction force vector generated by at least one of wheels 222.

In one embodiment, the platform 210 can be moved (indicated by arrow 242) by the omnidirectional wheels 222 to a new position 212 (indicated by the dotted circle), putting the new center of pressure position 234 safely within the stability zone of the platform 210. Essentially, the control system 112 associated with mobile robot assembly 100 implements stabilizing dynamic feedback control laws that move the corresponding mechanical dynamical system from a region of instability to a region of stability by reducing the tipping moment to zero.

In some embodiments, the control system 112 can be configured to account for various possible latencies or movements caused by third party actions (e.g. pushing, shoving, or other impact by a human, animal, or other robot). For example, when using a swerve drive the wheels must be oriented in some direction. If the mobile robot assembly 100 and connected platform 210 is to accelerate in that direction or required to lift a weight, the wheels can be pointed in the direction the robot needs to move the base. However, if the robot is shoved by a third party perpendicular to the orientation of the wheels, it cannot accelerate in that direction to compensate and the mobile robot assembly 100 can start to lean in the direction it was shoved while applying some torque at the base to slow its lean, while keeping the center of pressure inside the basin of support. At the same time, the wheels can be orienting themselves in the direction of the needed acceleration. As soon as the wheels reach the right orientation, then the robot base can accelerate in the direction, and correct the lean of the robot.

In another embodiment, tipping potential can be reduced when the platform quickly accelerates (arrow 242) in direction 233. Ordinarily this could result in tipping, but in this described embodiment, the robot body, the connecting ankle joint, the arm, knee, waist, or neck joints bend or lean forward in the direction of acceleration. Advantageously, leaning into the acceleration also allows for quicker acceleration. Another advantage is increased dynamic stability and an additional degree of control input for a mobile robot assembly to stay balanced. This is particularly useful for embodiments having a small platform and a tall robot, since it is possible to actively balance mobile robot assembly 100 in combination with platform 210 to increase stability.

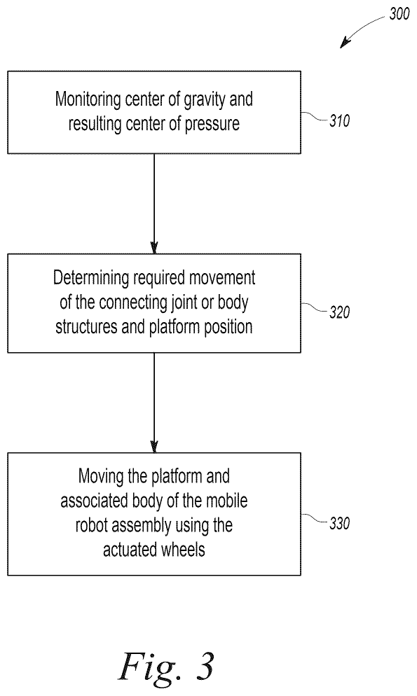

FIG. 3 illustrates a method 300 of maintaining balance of a movable robot with a body using actuated wheels and movement of a connecting joint. In step 310, center of gravity and resulting center of pressure (e.g., center of pressure 230) are monitored and determined (e.g., by a sensing system associated with mobile robot assembly 100). In step 320, required movement of the connecting joint or body structures and platform position is determined. In step 330, the platform and associated body of the mobile robot assembly are moved using the actuated wheels (e.g., based on outputs from control system 112). In some embodiments, movement of the platform (e.g., platform 120 or platform 210) is required in response to movement of connecting joints, body, arm, or knee, waist, or neck joints. In other embodiments, movement of connecting joints, body, arm, or knee, waist, or neck joints is required in response to acceleration of the platform. In some embodiments, acceleration of the base can be controlled in a manner that affects the COP. In effect, controlling the lean of the body can allow the platform and associated body of the mobile robot assembly to accelerate faster than if it did not lean. In still other embodiments, movement of connecting joints, body, arm, or knee, waist, or neck joints and the platform can be made in concert to provide more stable and fluid movement of the robot.

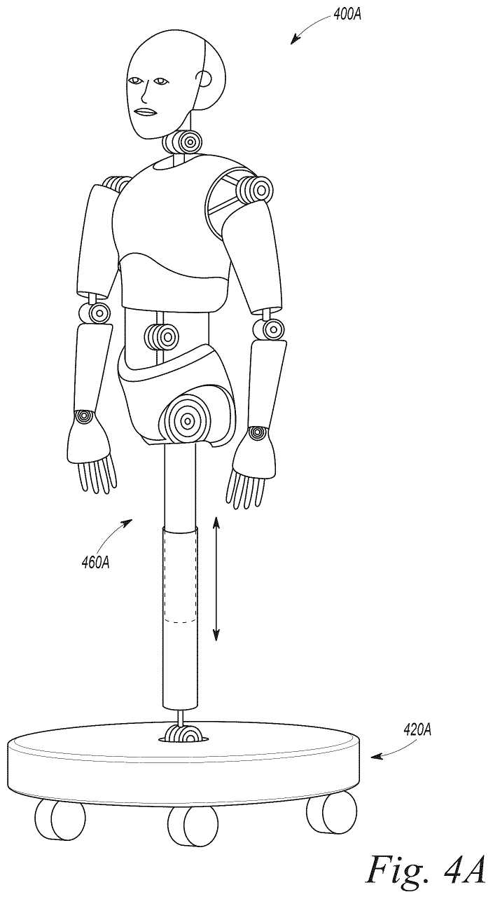

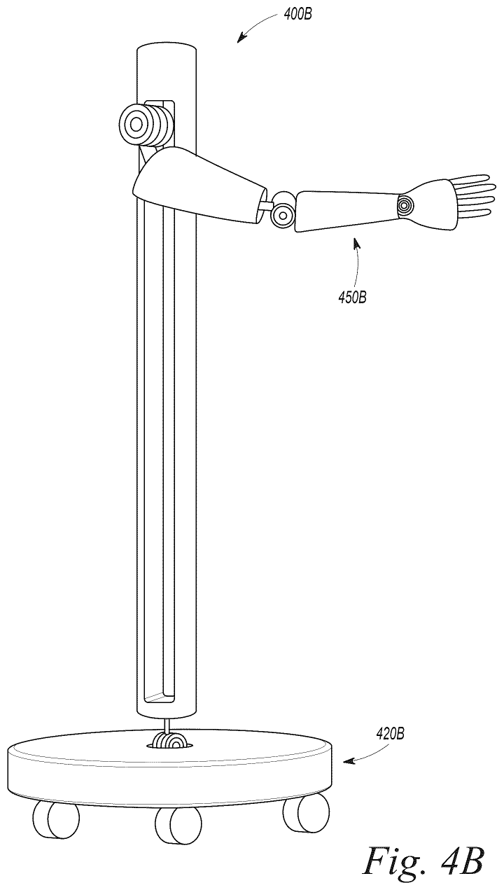

As will be understood, use of humanoid legs or limbs is not required. For example, FIG. 4A illustrates a mobile robot assembly 400A with humanoid legs replaced with an adjustable height column or pillar 460A that is attached to platform 420A. As another example, FIG. 4B illustrates a tall and thin robot assembly 400B with a single humanoid arm 450B on a platform 420B. In some embodiments, even this humanoid arm can be replaced with designs based, for example, on tentacles, extending piston(s), or inflatable limbs. Use of these or any described structures and methods herein allow such tip prone designs to be useful given enhanced static and dynamic stability as discussed.

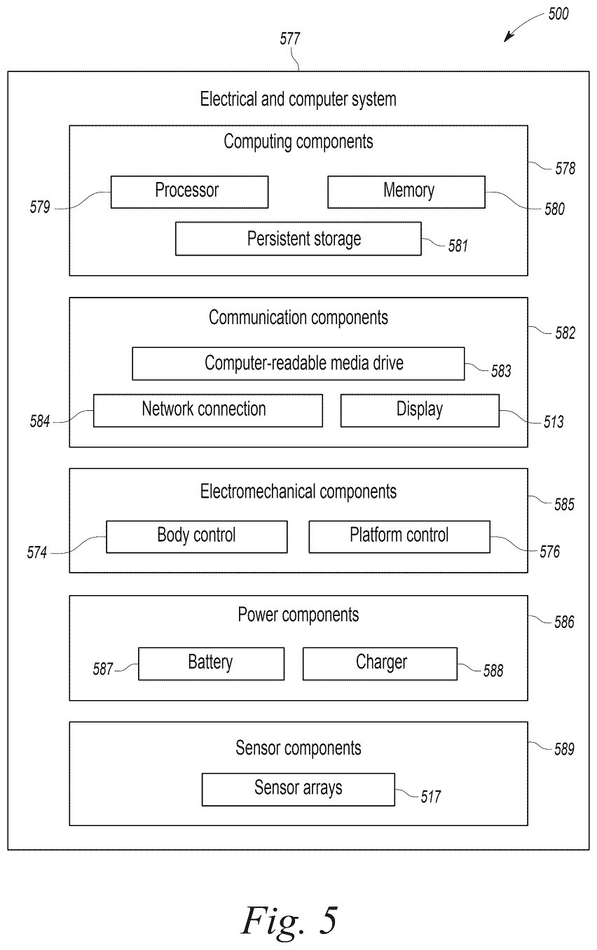

FIG. 5 is a block diagram 500 illustrating an electrical and computer system of a mobile robot such as illustrated in FIGS. 1, 4A, and 4B. When suitable, operations described elsewhere in this disclosure (e.g., movements of the mobile robot assembly 100 in FIG. 1) can be implemented via this electrical and computer system 577 autonomously and/or in response to instructions from a user. As shown in FIG. 5, the electrical and computer system 577 can include computing components 578. The computing components 578 can include a processor 579, such as one or more general-purpose and/or special-purpose integrated circuits including digital logic gates for executing programs and/or for otherwise processing data. The computing components 578 can further include memory 580, such as one or more integrated circuits for storing data in use. The memory 580 can include a multithreaded program, an operating system including a kernel, device drivers, etc. The computing components 578 can further include persistent storage 581, such as a hard drive for persistently storing data. Examples of data that can be stored by the persistent storage 581 include diagnostic data, sensor data, configuration data, environmental data, and current-state data. The computing components 578 can collectively define a computer configured to manage, control, receive information from, deliver information to, and/or otherwise usefully interact with other components of the electrical and computer system 577.

The electrical and computer system 577 can further include communication components 582. The communication components 582 can include a computer-readable media drive 583 for reading computer programs and/or other data stored on computer-readable media. As one example, the computer-readable media drive 583 can be a flash-memory drive. The communication components 582 can further include a network connection 584 for connecting the mobile robot assembly 100 to other devices and systems, such as other robots and/or other computer systems. The network connection 584 can be wired and/or wireless and can be via the Internet, a Local Area Network (LAN), a Wide Area Network (WAN), Bluetooth, Wi-Fi, or a cell phone network. The network connection 584 can include networking hardware, such as routers, switches, transmitters, receivers, computer-readable transmission media, etc. The communication components 582 can further include the display 513 and/or other suitable components for communicating with a user. The mobile robot assembly 100 can use the communication components 582 for internal operations and/or to interact with devices and/or systems external to the mobile robot assembly 100, such as systems for providing contextual information about the environment in which the mobile robot assembly 100 operates and/or systems for changing operating conditions of the mobile robot assembly 100. The communication components 582 can also be used to communicate state history data (e.g., position history, velocity history, acceleration history, control input history, and the state history of the various moving components of mobile robot assembly 100) to an external computing system. This state history data can be used as diagnostic data to continually evaluate and, if necessary, improve the performance of the mobile robot assembly 100.

The electrical and computer system 577 can further include electromechanical components 585. The electromechanical components 585 can include body control 574 and platform control 576 for implementing both external movement through an environment and mechanical action and movement within the mobile robot assembly 100. The electrical and computer system 577 can further include power components 586. The power components 586 can include a battery 587 and a charger 588. The battery 587 can be a lithium-ion battery, a lead-acid battery, or another suitable type of battery. The charger 588 can include a connector (not shown) compatible with a power source (e.g., a wall outlet) and leads (also not shown) extending between the connector and the battery 587.

Finally, the electrical and computer system 577 can include sensor components 589 for capturing, providing, and/or analyzing information about the mobile robot assembly 100 itself and/or the environment in which the mobile robot assembly 100 is operating. The sensor components 589 can include the sensor arrays 517. At the sensor arrays 517 or at one or more other suitable locations, the mobile robot assembly 100 can include among the sensor components 589 a light sensor (e.g., a photoresistor), a sound sensor (e.g., a microphone), an accelerometer, a gyroscope, a tilt sensor, tip sensors, a location sensor (e.g., using the Global Positioning System), a distance sensor, a contact sensor, and/or a proximity sensor, among other examples. The electro-optical wireless transceiver-based sensing described above for measuring joint rotation may also be included in sensor components 589. The mobile robot assembly 100 can include one or more sensors in a sensor system, such as a vision system, a light detection and ranging (LIDAR) system, a sound navigation and ranging (SONAR) system, etc. In at least some cases, the mobile robot assembly 100 monitors itself and/or its environment in real-time or in near real-time. Moreover, the mobile robot assembly 100 may use acquired sensor data as a basis for decision-making via the computing components 578.

Components of the electrical and computer system 577 can be connected to one another and/or to other components of the mobile robot assembly 100 via suitable conductors, transmitters, receivers, circuitry, etc. While the electrical and computer system 577 configured as described above may be used to support operation of the mobile robot assembly 100, it should be appreciated that the mobile robot assembly 100 may be operated using devices of various types and configurations and that such devices may have various components and levels of responsibility. For example, the mobile robot assembly 100 may employ individual computer systems or controllers to manage discrete aspects of its operations, such as an individual computer system or controller to perform computer vision operations, a separate computer system or controller to perform power management, etc. In some cases, the mobile robot assembly 100 employs the electrical and computer system 577 to control physical aspects of the mobile robot assembly 100 according to one or more designated rules encoded in software. For example, these rules can include minimums and/or maximums, such as a maximum degree of rotation for a joint, a maximum speed at which a component is allowed to move, a maximum acceleration rate for one or more components, etc. The mobile robot assembly 100 may include any number of mechanical aspects and associated rules, which may be based on or otherwise configured in accordance with the purpose of and/or functions performed by the mobile robot assembly 100.

Software features of the mobile robot assembly 100 may take the form of computer-executable instructions, such as program modules executable by the computing components 578. Generally, program modules include routines, programs, objects, components, data structures, and/or the like configured to perform particular tasks or to implement particular abstract data types and may be encrypted. Furthermore, the functionality of the program modules may be combined or distributed as desired in various examples. Moreover, control scripts may be implemented in any suitable manner, such as in C/C++ or Python. The functionality of the program modules may be combined or distributed in various embodiments, including cloud-based implementations, web applications, mobile applications for mobile devices, etc.

Furthermore, certain aspects of the present technology can be embodied in a special purpose computer or data processor, such as application-specific integrated circuits (ASIC), digital signal processors (DSP), field-programmable gate arrays (FPGA), graphics processing units (GPU), many core processors, etc. specifically programmed, configured, or constructed to perform one or more computer-executable instructions. While aspects of the present technology, such as certain functions, may be described as being performed on a single device, these aspects, when suitable, can also be practiced in distributed computing environments where functions or modules are shared among different processing devices linked through a communications network such as a Local Area Network (LAN), Wide Area Network (WAN), or the Internet. In a distributed computing environment, program modules and other components may be located in both local and remote memory storage and other devices, which may be in communication via one or more wired and/or wireless communication channels.

Aspects of the present technology may be stored or distributed on tangible computer-readable media, which can include volatile and/or non-volatile storage components, such as magnetically or optically readable computer media, hard-wired or preprogrammed chips (e.g., EEPROM semiconductor chips), nanotechnology memory, biological memory, or other computer-readable storage media. Alternatively, computer-implemented instructions, data structures, screen displays, and other data under aspects of the present technology may be distributed (encrypted or otherwise) over the Internet or over other networks (including wireless networks), on a propagated signal on a propagation medium (e.g., electromagnetic wave(s), sound wave, etc.) over a period of time, or they may be provided on any analog or digital network (packet switched, circuit switched, or other scheme). Furthermore, the term computer-readable storage medium does not encompass signals (e.g., propagating signals) or transitory media. One of ordinary skill in the art will recognize that various components of the mobile robot assembly 100 may communicate via any number of wired and/or wireless communication techniques. Additionally, elements of the robot assembly 100 may be distributed rather than located in a single monolithic entity. Accordingly, the disclosed systems and techniques may operate in one or more examples other than the examples provided above.

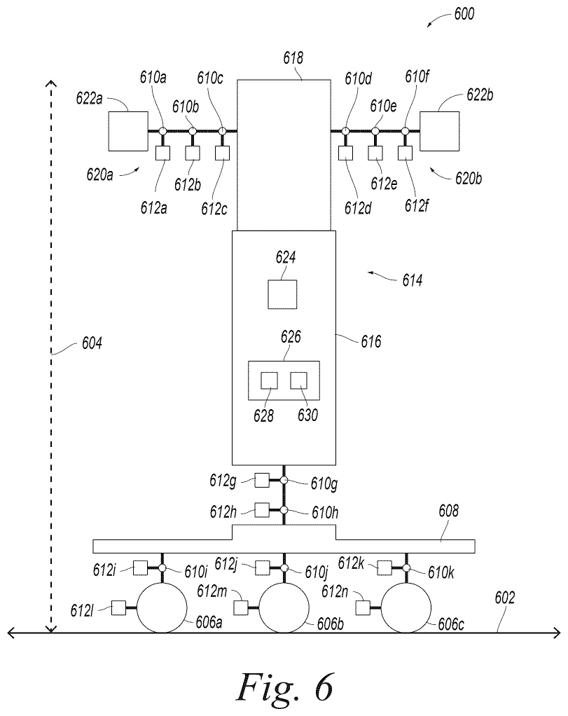

Referring now to FIG. 6, a partially schematic front profile view of a mobile robot 600 is shown in accordance with at least some embodiments of the present technology. The mobile robot 600 operates on a ground surface 602, which may be a horizontal ground surface, and defines a height 604 in a vertical dimension while the mobile robot 600 operates on the ground surface 602. The mobile robot 600 includes a wheel 606a configured to contact the ground surface 602 at a first location while the mobile robot 600 operates on the ground surface 602. Additionally, the mobile robot 600 includes a wheel 606b configured to contact the ground surface 602 at a second location different than the first location while the mobile robot 600 operates on the ground surface 602. Furthermore, the mobile robot 600 includes a wheel 606c configured to contact the ground surface 602 at a third location different than the first location and different than the second location while the mobile robot 600 operates on the ground surface 602. The wheel 606b and the wheel 606c may be spaced apart from the wheel 606a, thereby forming a plurality of additional wheels configured to contact the ground surface 602. The mobile robot 600 can still further include a support 608 carried by the wheel 606a, the wheel 606b, and the wheel 606c. The support 608 can provide a structural foundation for upper components of the mobile robot 600.

The support 608 may be configured in various forms suitable for carrying the upper components of the mobile robot 600 while interfacing with the wheel 606a, the wheel 606b, and the wheel 606c. In some embodiments, the support 608 may have a generally planar configuration with a superior surface facing upward and an inferior surface facing the ground surface 602, wherein the wheels are attached to or near a perimeter of the inferior surface. The support 608 may be generally circular, rectangular, triangular, or polygonal in shape when viewed from above, with the particular shape selected based on factors such as desired stability characteristics, maneuverability requirements, and spatial constraints of the operating environment. In certain configurations, the support 608 may include a frame structure with openings or cutouts to reduce weight while maintaining structural rigidity sufficient to support upper components of the mobile robot 600 and to withstand forces encountered during operation. The support 608 may be fabricated from materials such as aluminum, steel, carbon fiber composites, or engineering plastics, with material selection based on considerations including strength-to-weight ratio, durability, and manufacturing cost. Furthermore, the support 608 may incorporate mounting features such as brackets, flanges, or attachment points for securing the joints, actuators, and other components that connect the wheels and upper components of the mobile robot 600 to the support 608.

With continued reference to FIG. 6, the wheel 606a, the wheel 606b, and the wheel 606c may be implemented in various configurations to enable movement of the mobile robot 600 across the ground surface 602. In some cases, the wheels may be implemented as swerve drive wheels with motors enabling movement in any direction, thereby allowing the support 608 to translate along the ground surface 602 without requiring reorientation of the mobile robot 600. Alternatively, the wheels may be implemented as omni-wheels enabling omnidirectional movement, which similarly permits the mobile robot 600 to move in any planar direction relative to the ground surface 602. Furthermore, the wheel 606b and the wheel 606c may be omnidirectional in some configurations. In these and other configurations, the wheel 606b and the wheel 606c may be nonactuated such that the wheel 606a provides primary propulsion while the wheel 606b and the wheel 606c roll passively along the ground surface 602.

The mobile robot 600 may further comprise a fourth wheel (not shown) configured to contact the ground surface 602 at a fourth location different than the first location, different than the second location, and different than the third location while the mobile robot 600 operates on the ground surface 602. In such configurations, the wheel 606a, the wheel 606b, the wheel 606c, and the fourth wheel may define a rectangular support polygon of the mobile robot 600 while the mobile robot 600 operates on the ground surface 602. The support 608 may thus be conceptualized as a foot that can roll in any direction, with the rectangular support polygon providing a wide base footprint that allows the mobile robot 600 to lean significantly while the spinning wheels provide time to respond to balance disturbances. Moreover, a center of pressure of the mobile robot 600 may be positioned anywhere within the support polygon without the mobile robot 600 falling, thereby providing enhanced stability margins during operation.

The mobile robot 600 can have a statically stable operational state in which the wheel 606a, the wheel 606b, and the wheel 606c are in contact with the ground surface 602 and in which the support 608 is stationary relative to the ground surface 602. In this statically stable operational state, the mobile robot 600 may remain upright without active control or power, unlike conventional high aspect-ratio wheeled configurations that require continuous active balancing to prevent falling. The mobile robot 600 can also have a dynamically stable operational state in which the wheel 606a, the wheel 606b, and the wheel 606c are in contact with the ground surface 602 and in which the support 608 is in motion relative to the ground surface 602. Thus, the mobile robot 600 may transition between statically stable and dynamically stable operational states depending on operational requirements. The support 608 can provide a compact base enabling navigation in small spaces while still permitting the mobile robot 600 to achieve static stability when stationary, thereby combining maneuverability with robust stability capabilities in accordance with at least some embodiments of the present technology.

As shown in FIG. 6, the mobile robot 600 can include a joint 610i through which the wheel 606a is movably connected to the support 608, thereby providing a wheel-to-support connector that enables articulated movement between the wheel 606a and the support 608. An actuator 612l is configured to drive rotation of the wheel 606a relative to the support 608 about a first axis, and the first axis may be within 15 degrees of horizontal when the wheel 606a, the wheel 606b, and the wheel 606c are in contact with the ground surface 602. Additionally, an actuator 612i is configured to drive rotation of the wheel 606a relative to the support 608 about a second axis different than the first axis, and the second axis may be within 15 degrees of perpendicular to the first axis in accordance with at least some embodiments of the present technology. The actuator 612l and the actuator 612i can thus be configured to cause relative rotation between the wheel 606a and the support 608 about the first axis and the second axis, respectively, wherein the first and second axes are different from one another. In some cases, the second axis may be within 15 degrees of horizontal when the wheel 606a, the wheel 606b, and the wheel 606c are in contact with the ground surface 602, thereby enabling the wheel 606a to be steered in a manner that permits omnidirectional movement of the support 608 along the ground surface 602. Alternatively, the second axis may be within 15 degrees of vertical when the wheel 606a, the wheel 606b, and the wheel 606c are in contact with the ground surface 602, which may facilitate a swerve drive configuration wherein the wheel 606a rotates about a substantially vertical steering axis while also rotating about a substantially horizontal drive axis.

The wheel 606b is similarly connected to the support 608 through a joint 610j, which provides a wheel-to-support connector for the wheel 606b. An actuator 612m is configured to drive rotation of the wheel 606b relative to the support 608 about an axis, and an actuator 612j is configured to drive rotation of the wheel 606b relative to the support 608 about another axis via the joint 610j. Furthermore, the wheel 606c is connected to the support 608 through a joint 610k, which provides a wheel-to-support connector for the wheel 606c. An actuator 612n is configured to drive rotation of the wheel 606c relative to the support 608 about an axis, and an actuator 612k is configured to drive rotation of the wheel 606c relative to the support 608 about another axis via the joint 610k. The actuator configurations for the wheel 606b and the wheel 606c may mirror the actuator configuration for the wheel 606a, such that each wheel has two degrees of freedom relative to the support 608 enabling both propulsion and steering. In certain embodiments, the actuators associated with the wheel 606b and the wheel 606c may operate in a coordinated manner with the actuator 612l and the actuator 612i to enable the support 608 to translate in any direction along the ground surface 602 without requiring the mobile robot 600 to first rotate to face a desired direction of travel. Moreover, the joint 610i, the joint 610j, and the joint 610k may each comprise bearing assemblies or other rotational coupling mechanisms that permit smooth articulation between the respective wheels and the support 608 while transmitting loads from the support 608 to the ground surface 602 through the wheel 606a, the wheel 606b, and the wheel 606c.

The wheel 606a, the wheel 606b, and the wheel 606c may each have various structural forms suitable for enabling movement of the mobile robot 600 while supporting the weight of the support 608 and upper components of the mobile robot 600. In some embodiments, each wheel may comprise a tire mounted on a rim, wherein the tire provides a compliant contact surface that absorbs minor irregularities in the ground surface 602 while the rim provides structural rigidity for mounting to the respective joint. The tires may be fabricated from rubber, polyurethane, or other elastomeric materials selected based on factors such as traction, durability, and noise characteristics. In certain configurations, the wheels may comprise solid wheels without pneumatic or foam-filled tires, which may be advantageous in environments where puncture resistance is important or where consistent wheel diameter is useful to facilitate precise odometry. The wheels may be mounted to the support 608 through various attachment mechanisms including cantilever mounts extending from the inferior surface of the support 608, fork-style mounts that straddle each wheel, or integrated housing assemblies that enclose the wheel actuators and joints within protective enclosures. In embodiments utilizing omni-wheels, each wheel may comprise a primary wheel body with a plurality of smaller rollers mounted around the circumference of the primary wheel body, wherein the smaller rollers are oriented perpendicular to the primary rotation axis to permit lateral sliding motion while the primary wheel body rotates for propulsion. The mounting arrangements may further include suspension elements such as springs, dampers, or compliant bushings that permit limited vertical travel of each wheel relative to the support 608, thereby enabling the mobile robot 600 to maintain ground contact across all wheels when traversing uneven terrain or when weight distribution shifts during manipulation tasks.

With reference again to the illustrated embodiment, the mobile robot 600 can further include a body 614 carried by the support 608. The body 614 can include an inferior portion 616 positioned toward the support 608 and a superior portion 618 positioned away from the support 608 along the height 604. The body 614 can be connected to the support 608 via a joint 610h, which is carried by the support 608 and provides a body-to-support connector through which the body 614 is movably connected to the support 608. Additionally, the body 614 can be connected to the support 608 via a joint 610g, which is also carried by the support 608 and provides a second joint of the body-to-support connector. The joint 610h and the joint 610g together can function like an ankle joint allowing the body 614 to lean in any direction relative to the support 608, thereby enabling the mobile robot 600 to shift mass distribution quickly in response to acceleration or external disturbances in accordance with at least some embodiments of the present technology.

An actuator 612h of the mobile robot 600 can be configured to drive rotation of the body 614 relative to the support 608 via the joint 610h about a third axis. Furthermore, an actuator 612g of the mobile robot 600 can be configured to drive rotation of the body 614 relative to the support 608 via the joint 610g about a fourth axis different from the third axis. The third and fourth axes can be different from one another, and the fourth axis may be within 15 degrees of perpendicular to the third axis in accordance with at least some embodiments of the present technology. The joint 610h and the joint 610g may together provide at least two rotational degrees of freedom for pitch and roll movements of the body 614 relative to the support 608, thereby enabling the body 614 to lean forward, backward, or sideways as operational conditions require.

In certain embodiments, the mobile robot 600 may further comprise another actuator (not shown) at the body-to-support connector configured to cause relative rotation between the body 614 and the support 608 about a fifth axis different from the third and fourth axes. The fifth axis may be within 15 degrees of perpendicular to the fourth axis, thereby providing a third degree of freedom that includes yaw rotation in addition to pitch and roll. Thus, the body-to-support connector may have three degrees of freedom to include yaw rotation, which permits the body 614 to rotate about a substantially vertical axis relative to the support 608 while also being able to tilt in pitch and roll directions. This three-degree-of-freedom configuration may enhance the ability of the mobile robot 600 to orient the body 614 independently of the direction of travel of the support 608 along the ground surface 602. This can be particularly useful when the wheel 606a, the wheel 606b, and the wheel 606c are swerve-type rather than omnidirectional.

The body-to-support connector comprising the joint 610h and the joint 610g may be implemented in various configurations suitable for enabling articulated movement between the body 614 and the support 608. In some embodiments, the body-to-support connector may comprise a gimbal mechanism with concentric rings that permit rotation about multiple orthogonal axes while maintaining structural rigidity under load. Alternatively, the body-to-support connector may comprise a universal joint or cardan joint configuration wherein two hinges oriented perpendicular to one another provide two rotational degrees of freedom. In certain configurations, the body-to-support connector may comprise a spherical joint or ball-and-socket joint that permits rotation about any axis passing through the joint center, with actuators positioned to drive controlled rotation about selected axes while constraining rotation about other axes. The body-to-support connector may further comprise bearing assemblies such as angular contact bearings, spherical roller bearings, or plain bearings that support the loads transmitted between the body 614 and the support 608 while permitting smooth rotational movement with minimal friction. In embodiments requiring three degrees of freedom, the body-to-support connector may comprise a combination of serial rotary joints arranged to provide pitch, roll, and yaw rotation, or may comprise a parallel mechanism with multiple actuated linkages that collectively control the orientation of the body 614 relative to the support 608.

In at least some cases, the joint 610h is positioned at a lowermost portion (e.g., third, quarter, or fifth) of the mobile robot 600 along the height 604 when the mobile robot 600 operates on the ground surface 602. The body-to-support connector comprising the joint 610h and the joint 610g can be similarly positioned along the height 604. Moreover, a total mass of the mobile robot 600 above the joint 610h along the height 604 can be greater than a total mass of the mobile robot 600 below the joint 610h along the height 604 when the mobile robot 600 operates on the ground surface 602. This mass distribution may create an inverted pendulum configuration wherein the majority of the mass of the mobile robot 600 is concentrated in the body 614 above the body-to-support connector. This configuration can benefit from active stabilization provided by coordinated operation of the actuator 612g, the actuator 612h, and the wheel actuators. The total mass of the mobile robot 600 above the body-to-support connector along the height 604 can thus be greater than the total mass of the mobile robot 600 below the body-to-support connector along the height 604. This mass concentration in the body 614 can enable the mobile robot 600 to leverage joint articulation for effective center of pressure adjustment during dynamic maneuvers.

The mobile robot 600 can include an arm 620a carried by the body 614 at the superior portion 618. The mobile robot 600 can be configured to manipulate objects via the arm 620a in accordance with at least some embodiments of the present technology. The arm 620a can include a joint 610a, a joint 610b, and a joint 610c that provide multiple degrees of freedom for articulated movement of the arm 620a relative to the body 614. Additionally, the arm 620a can include an actuator 612a configured to drive rotation at the joint 610a, an actuator 612b configured to drive rotation at the joint 610b, and an actuator 612c configured to drive rotation at the joint 610c. The joint 610a, the joint 610b, and the joint 610c may be arranged in series along the arm 620a to provide a kinematic chain enabling the arm 620a to reach various positions and orientations within a workspace surrounding the mobile robot 600. Furthermore, the actuator 612a, the actuator 612b, and the actuator 612c may operate in a coordinated manner to position the arm 620a for grasping, lifting, placing, or otherwise manipulating objects encountered by the mobile robot 600 during operation.

The arm 620a terminates in an end effector 622a of the mobile robot 600, which provides a terminal manipulation interface for interacting with objects in the environment of the mobile robot 600. The end effector 622a may comprise a gripper, a hand-like structure with multiple digits, or another manipulation device configured to grasp and release objects as operational tasks require. Thus, the arm 620a extends from the body 614 at the superior portion 618 and provides the mobile robot 600 with manipulation capabilities that complement the mobility provided by the wheel 606a, the wheel 606b, and the wheel 606c at the support 608.

The mobile robot 600 can further include an arm 620b carried by the body 614 at the superior portion 618. The mobile robot 600 can similarly be configured to manipulate objects via the arm 620b. The arm 620b comprises a joint 610d, a joint 610e, and a joint 610f that provide multiple degrees of freedom for articulated movement of the arm 620b relative to the body 614. Moreover, the arm 620b comprises an actuator 612d configured to drive rotation at the joint 610d, an actuator 612e configured to drive rotation at the joint 610e, and an actuator 612f configured to drive rotation at the joint 610f. The joint 610d, the joint 610e, and the joint 610f may be arranged in a configuration similar to the joints of the arm 620a, thereby providing the arm 620b with comparable reach and dexterity for manipulation tasks. The actuator 612d, the actuator 612e, and the actuator 612f may operate independently or in coordination with the actuators of the arm 620a to enable bimanual manipulation wherein both arms work together to handle larger objects or perform tasks requiring coordinated dual-arm motion.

The arm 620b can terminate in an end effector 622b of the mobile robot 600, which provides a terminal manipulation interface for the arm 620b. The end effector 622b may be configured similarly to the end effector 622a, or the end effector 622b may have a different configuration suited to complementary manipulation tasks. In certain embodiments, the end effector 622a and the end effector 622b may work in concert to manipulate a single object from multiple grasp points, thereby enabling the mobile robot 600 to handle objects that exceed the capacity of a single arm. The arm 620a and the arm 620b together can provide the mobile robot 600 with enhanced manipulation capabilities that enable the mobile robot 600 to perform a variety of tasks including grasping objects, transferring objects between locations, and interacting with elements in the environment while the support 608 maintains position on the ground surface 602 or while the mobile robot 600 traverses the ground surface 602 in the dynamically stable operational state.

The mobile robot 600 further includes an inertial measurement system 624 at the body 614. The inertial measurement system 624 can be configured to provide orientation information regarding the spatial orientation of the body 614 relative to the ground surface 602 and relative to gravitational reference frames. The inertial measurement system 624 may comprise accelerometers, gyroscopes, magnetometers, or combinations thereof that collectively sense linear acceleration, angular velocity, and magnetic field orientation to determine the orientation of the body 614 in three-dimensional space. In accordance with at least some embodiments of the present technology, the inertial measurement system 624 may be positioned within the body 614 at a location that provides representative measurements of body orientation while reducing interference from vibrations or other noise sources that might degrade measurement accuracy.

The mobile robot 600 further comprises a controller 626 including a processor 628 and memory 630. The controller 626 can be configured to receive orientation information from the inertial measurement system 624. The processor 628 may comprise a microprocessor, a microcontroller, a digital signal processor, a field-programmable gate array, or another computational device capable of executing instructions and processing sensor data in real time. Moreover, the memory 630 may comprise volatile memory such as random access memory for storing data during active processing, non-volatile memory such as flash memory for storing persistent instructions and configuration parameters, or combinations of volatile and non-volatile memory types. The controller 626 may be disposed within the body 614 in proximity to the inertial measurement system 624, or the controller 626 may be positioned at another location within the mobile robot 600 and connected to the inertial measurement system 624 via wired or wireless communication links.

The memory 630 can store instructions that, when executed via the processor 628, cause the mobile robot 600 to maintain dynamic stability via coordinated operation of the actuator 612l, the actuator 612i, the actuator 612h, and the actuator 612g. As described previously, the actuator 612l and the actuator 612i can be configured to cause relative rotation between the wheel 606a and the support 608 about the first axis and the second axis, respectively. The actuator 612h and the actuator 612g can be configured to cause relative rotation between the body 614 and the support 608 about the third axis and the fourth axis, respectively. The instructions, when executed via the processor 628, can cause the mobile robot 600 to maintain dynamic stability in the dynamically stable operational state via coordinated operation of at least the actuator 612l, the actuator 612i, the actuator 612h, and the actuator 612g based at least partially on the orientation information received from the inertial measurement system 624. Thus, the controller 626 processes the orientation information to determine appropriate actuator commands that maintain the body 614 in a desired upright posture while the support 608 moves relative to the ground surface 602.

The mobile robot 600 may be configured with various combinations of actuated and non-actuated wheels depending on the desired mobility characteristics and control complexity. In some embodiments, all of the wheel 606a, the wheel 606b, and the wheel 606c may be actuated with both drive and steering capabilities, thereby providing maximum control authority for omnidirectional movement and dynamic stabilization. In other embodiments, only the wheel 606a may be fully actuated with the actuator 612l and the actuator 612i while the wheel 606b and the wheel 606c are non-actuated passive wheels that roll freely in response to movement of the support 608. When fewer wheels are actuated, the non-actuated wheels may be implemented as omnidirectional wheels that permit lateral sliding motion through rollers mounted around their circumference, thereby allowing the support 608 to translate in any direction even though propulsion is provided by a single actuated wheel. Alternatively, when swerve drive configurations are employed wherein each actuated wheel can be steered to point in any direction, the non-actuated wheels may similarly be implemented as swivel casters that passively orient themselves in the direction of travel. The selection between omnidirectional wheels and swivel wheels for non-actuated positions may depend on factors such as load capacity requirements, floor surface characteristics, and the desired responsiveness of the mobile robot 600 to commanded movements. In configurations where all wheels are actuated with swerve drive capabilities, the wheels must be coordinated to point in compatible directions for translation or to define a circular trajectory for rotation, whereas omnidirectional wheel configurations permit independent control of each wheel speed without requiring wheel reorientation.

The controller 626 can implement a feedback control loop that continuously monitors platform orientation, angular velocity, wheel speed, and joint position to compute actuator commands that maintain dynamic stability of the mobile robot 600. In these and other cases, the orientation information from the inertial measurement system 624 can provide measurements of the angular displacement and angular rate of change of the body 614, which the controller 626 uses to detect deviations from a desired equilibrium orientation. Additionally, the controller 626 may receive wheel speed information from encoders or other sensors associated with the wheel 606a, the wheel 606b, and the wheel 606c, and the controller 626 may receive joint position information from encoders or other sensors associated with the joint 610h and the joint 610g. The feedback control loop can process these sensor inputs to generate coordinated commands for the actuator 612l, the actuator 612i, the actuator 612h, and the actuator 612g that attempt to minimize deviation from the desired upright posture while respecting actuator limits and avoiding oscillations or instability that could arise from conflicting control actions.

In accordance with at least some embodiments of the present technology, the instructions stored in the memory 630, when executed via the processor 628, cause the mobile robot 600 to maintain dynamic stability via coordinated operation of the actuator 612l, the actuator 612i, and the actuator 612h based at least partially on the orientation information. The actuator 612h is configured to drive rotation of the body 614 relative to the support 608 via the joint 610h, thereby providing joint actuation that shifts the center of mass of the body 614 relative to the support 608. Furthermore, the controller 626 may coordinate the wheel actuation provided by the actuator 612l and the actuator 612i with the joint actuation provided by the actuator 612h to achieve complementary stabilization effects wherein the wheels provide rapid response to immediate balance threats through ground reaction forces while the joint provides slower but sustained adjustments to overall mass distribution.

The control system of the mobile robot 600 can maintain dynamic stability through coordinated operation of wheel actuators and body-to-support actuators that operate on different timescales with complementary characteristics in accordance with at least some embodiments of the present technology. The instructions stored in the memory 630, when executed via the processor 628, can cause the mobile robot 600 to operate the actuator 612l and the actuator 612i on a first timescale and to operate the actuator 612h and the actuator 612g on a second timescale different than the first timescale. The first timescale may be faster than the second timescale, such that the wheel actuation provides rapid response to immediate balance threats through ground reaction forces while the joint actuation provides slower but sustained adjustments to overall mass distribution. This temporal separation between wheel control and joint control can enable the mobile robot 600 to address both immediate perturbations and longer-term postural adjustments through distinct but coordinated control channels. Moreover, the instructions, when executed via the processor 628, can cause the mobile robot 600 to operate the actuator 612l and the actuator 612i on the first timescale and to operate the actuator 612h on the second timescale different than the first timescale, thereby establishing a hierarchical control structure wherein wheel dynamics respond more quickly than joint dynamics.

The controller 626 can anticipate acceleration and lean the body 614 such that acceleration cannot tip the mobile robot 600 over, thereby implementing an anticipatory lean control strategy that proactively maintains stability during aggressive maneuvers rather than merely reacting to tipping after tipping begins. When the body 614 leans forward, the wheel 606a may accelerate forward while the joint 610h may articulate to swing the body 614 rearward, effectively counterbalancing the tilt through coordinated actuation of both control authorities. This anticipatory approach can enable the mobile robot 600 to lean into acceleration in a manner analogous to a motorcyclist leaning into a turn, wherein the lean angle is established before or during the acceleration event rather than as a corrective response to detected instability. Furthermore, the control system can use feedforward terms to anticipate known disturbances such as terrain changes or commanded movements, which permits the controller 626 to preemptively adjust wheel torque and joint torque before disturbances propagate through the system and cause measurable deviations from the desired upright posture.

In at least some cases, the control system allows the mobile robot 600 to intentionally violate center-of-pressure rules to achieve faster acceleration, which represents a departure from conventional wheeled robot control strategies that maintain the center of pressure within conservative bounds to avoid tipping. By combining the wide base footprint provided by the support polygon with active dynamic balancing through coordinated wheel and joint actuation, the mobile robot 600 may permit the center of pressure to approach or temporarily exceed the boundaries of the support polygon during transient acceleration events while the spinning wheels and articulating joints work in concert to prevent falling. This capability may enable the mobile robot 600 to accelerate more quickly than conventional robots. The static base can provide a stable foundation from which dynamic maneuvers can be initiated and to which the mobile robot 600 can return when aggressive motion is no longer required.

The controller 626 may compute optimal commands for both wheel torque and joint torque while respecting actuator limits, thereby generating control signals that maximize stabilization effectiveness without exceeding the torque capacity, speed limits, or range of motion constraints of the individual actuators. The coupling between wheel dynamics and joint dynamics may involve tuning to prevent oscillations or instability from conflicting control actions. Relatedly, the controller 626 may implement decoupling strategies, gain scheduling, or other control techniques that account for the mechanical and dynamic interactions between the wheel subsystem and the joint subsystem. Additionally, the feedback control loop may incorporate rate limiting, anti-windup mechanisms, or other safeguards that prevent actuator saturation from degrading control performance during large disturbances or rapid commanded movements.

During steady-state operation, the joint angle may be held constant while the wheel makes continuous small corrections, which tends to reduce energy consumption and actuator wear by minimizing unnecessary joint motion when the mobile robot 600 is operating in a relatively stable configuration. In contrast, during larger disturbances or transitions between operating modes, both wheel and joint actuators may work in concert, with the wheel actuators providing immediate corrective forces through ground contact while the joint actuators redistribute mass to assist in recovery or to prepare for subsequent maneuvers. For a single actively driven wheel configuration, the wheel torque may provide the primary mechanism for arresting a fall by driving the ground contact point beneath the shifting center of gravity, while the joint between the body 614 and the support 608 provides a secondary control authority that can redistribute mass to assist in recovery or to anticipate disturbances.

In general, the mobile robot 600 can provide greater stability through combined static base capability and dynamic balancing, which may be more effective than either approach alone, because the wide support polygon permits larger lean angles before the center of pressure exits the support boundary while the dynamic balancing permits recovery from lean angles that would cause a purely static system to fall. Moreover, the mobile robot 600 may have more control authority and freedom of movement while balancing compared to conventional counterparts, because the dual control authorities of wheel actuation and joint actuation provide independent but coordinated systems for influencing the center of pressure and center of gravity relationship. This enhanced control authority can enable the mobile robot 600 to perform tasks such as carrying loads, reaching into confined spaces, or operating in dynamic environments where external forces or uneven terrain would destabilize robots relying on either static stability or dynamic balancing alone.

A method of operating a mobile robot (e.g., the mobile robot 600) for dynamic stability in accordance with at least some embodiments of the present technology comprises causing rotation of a first wheel (e.g., the wheel 606a) of the mobile robot relative to a support (e.g., the support 608) of the mobile robot about a first axis via a first actuator (e.g., the actuator 612l) of the mobile robot while the support is carried by the first wheel, a second wheel (e.g., the wheel 606b), and a third wheel (e.g., the wheel 606c) of the mobile robot. The first actuator may be configured to drive the first wheel in a manner that propels the support along a ground surface (e.g., the ground surface 602), and the rotation about the first axis may correspond to a drive rotation that translates the support in a direction determined by the orientation of the first wheel relative to the support. Additionally, the method comprises causing rotation of the first wheel relative to the support about a second axis via a second actuator (e.g., the actuator 612i) of the mobile robot while the support is carried by the first wheel, the second wheel, and the third wheel. The second actuator may be configured to steer the first wheel or otherwise reorient the first wheel relative to the support, thereby enabling the mobile robot to change direction of travel without requiring the entire support to rotate about a vertical axis. During the method, the second axis may be within 15 degrees of perpendicular to the first axis, such that the first axis and the second axis define substantially orthogonal rotational degrees of freedom for the first wheel relative to the support.

The method further comprises causing rotation of a body (e.g., the body 614) of the mobile robot relative to the support at a joint (e.g., the joint 610h) of the mobile robot via a third actuator (e.g., the actuator 612h) of the mobile robot while the body is connected to the support via the joint. The third actuator may drive articulation of the body relative to the support in a manner that shifts the center of mass of the body, thereby altering the relationship between the center of gravity of the mobile robot and the center of pressure at the ground surface. Moreover, the method comprises maintaining dynamic stability of the mobile robot via coordinated operation of the first actuator, the second actuator, and the third actuator, wherein the coordinated operation involves generating actuator commands that work in concert to prevent the mobile robot from tipping while the support moves relative to the ground surface. The coordinated operation may involve simultaneous or sequential actuation of the first actuator, the second actuator, and the third actuator based on sensor feedback and control algorithms that determine appropriate torque or velocity commands for each actuator in accordance with at least some embodiments of the present technology.

In certain embodiments, the joint is a first joint, and causing rotation of the body relative to the support includes causing rotation of the body relative to the support via the first joint about a third axis. The method may further comprise causing rotation of the body relative to the support via a second joint (e.g., the joint 610g) of the mobile robot about a fourth axis different than the third axis while the body is connected to the support via the second joint. The first joint and the second joint together provide multiple rotational degrees of freedom that enable the body to tilt in pitch and roll directions relative to the support, thereby permitting the mobile robot to lean forward, backward, or sideways as operational conditions require. Furthermore, causing the rotation of the body relative to the support via the second joint about the fourth axis may include causing the rotation of the body relative to the support via the second joint about the fourth axis while the fourth axis is within 15 degrees of perpendicular to the third axis. This perpendicular relationship between the third axis and the fourth axis enables independent control of body orientation in two orthogonal planes, which provides enhanced flexibility for adjusting the center of mass position during dynamic maneuvers.

During the method, the mobile robot defines a height (e.g., the height 604) in a vertical dimension, and a total mass of the mobile robot above the joint along the height can be greater than a total mass of the mobile robot below the joint along the height. This mass distribution may create an inverted pendulum configuration wherein the majority of the mass is positioned above the joint connecting the body to the support, which may benefit from active stabilization through coordinated actuator operation. Additionally, during the method, the joint may be at a lowermost third of the mobile robot along the height, such that the body-to-support connection is positioned relatively low on the mobile robot while the mass concentration remains in the body above the joint. This positioning may enable the joint to function analogously to an ankle joint that permits the body to lean relative to the support while the support maintains contact with the ground surface through the wheels.

Maintaining the dynamic stability of the mobile robot may include maintaining the dynamic stability of the mobile robot via coordinated operation of the first actuator, the second actuator, and the third actuator based at least partially on orientation information from an inertial measurement system (e.g., the inertial measurement system 624) of the mobile robot at the body. The inertial measurement system may provide measurements of angular displacement, angular velocity, and linear acceleration that the control system processes to determine the current orientation of the body and to predict future orientation changes based on current motion trends. Thus, the coordinated operation of the actuators may be responsive to real-time sensor feedback that enables the control system to detect deviations from a desired upright posture and to generate corrective commands before the deviations grow large enough to cause instability.

During the method, the first wheel, the second wheel, the third wheel, and a fourth wheel of the mobile robot may define a rectangular support polygon of the mobile robot. The rectangular support polygon may provide a wide base footprint that establishes boundaries within which the center of pressure may be positioned without causing the mobile robot to tip, and the four-wheel configuration may enhance stability margins compared to three-wheel configurations by providing a larger support polygon area. The rectangular arrangement of the wheels may enable the mobile robot to lean in any direction while maintaining at least three wheels in contact with the ground surface, thereby providing redundancy in ground contact that enhances robustness against uneven terrain or localized disturbances at individual wheel locations in accordance with at least some embodiments of the present technology.

This disclosure is not intended to be exhaustive or to limit the present technology to the precise forms disclosed herein. Although specific embodiments are disclosed herein for illustrative purposes, various modifications are possible without deviating from the present technology, as those of ordinary skill in the relevant art will recognize. In some cases, well-known structures and functions have not been shown or described in detail to avoid unnecessarily obscuring the description of the embodiments. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like are used throughout this disclosure to mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “comprising two arms” means including at least two arms. References herein to any of “receiving,” “determining,” or “generating” information in accordance with various embodiments of the present technology encompass, when feasible, the others of “receiving,” “determining,” and “generating” the information and indicate that such operations can occur at least partially via the relevant computing subsystem. As used herein, the terms “based on,” “by,” “via,” and the like do not imply exclusivity unless the context clearly indicates otherwise. Thus, “based on” means based at least partially on, “by” means at least partially by, and “via” means at least partially via.

Directional terms, such as “upper,” “lower,” “front,” “back,” “vertical,” “horizontal,” “anterior,” “posterior,” “dorsal,” “lateral,” “superior,” and “inferior,” may be used herein to express and clarify the relationship between various structures. It should be understood that such terms do not denote absolute orientation but rather describe relative positioning. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Also, different combinations of features from various embodiments may be implemented together. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. The term “real-time” as used herein should be understood to encompass not only instantaneous processing but also processing with some delay that is sufficiently responsive for the particular operational context, and may include near-real-time processing with acceptable latency for the specific application requirements. Finally, it should be noted that various particular features, structures, and operations of the embodiments described herein may be combined in any suitable manner in additional embodiments in accordance with the present technology.

1-20. (canceled)

21. A mobile robot comprising:
a wheel configured to contact a ground surface;
a plurality of additional wheels configured to contact the ground surface and spaced apart from the wheel;
a support carried by the wheel and the plurality of additional wheels;
a wheel-to-support connector through which the wheel is movably connected to the support;
a first actuator and a second actuator configured to cause relative rotation between the wheel and the support about a first axis and a second axis, respectively, wherein the first and second axes are different from one another;
a body carried by the support;
a body-to-support connector through which the body is movably connected to the support;
a third actuator and a fourth actuator configured to cause relative rotation between the body and the support about a third axis and a fourth axis, respectively, wherein the third and fourth axes are different from one another; and
an arm carried by the body, wherein the mobile robot is configured to manipulate objects via the arm,
wherein the mobile robot has:
a statically stable operational state in which the wheel and the plurality of additional wheels are in contact with the ground surface and in which the support is stationary relative to the ground surface, and
a dynamically stable operational state in which the wheel and the plurality of additional wheels are in contact with the ground surface and in which the support is in motion relative to the ground surface, and
wherein the mobile robot further comprises a controller including:
a processor, and
memory storing instructions that, when executed via the processor, cause the mobile robot to maintain dynamic stability in the dynamically stable operational state via coordinated operation of at least the first actuator, the second actuator, the third actuator, and the fourth actuator.

22. The mobile robot of claim 21, wherein the second axis is within 15 degrees of perpendicular to the first axis.

23. The mobile robot of claim 22, wherein the fourth axis is within 15 degrees of perpendicular to the third axis.

24. The mobile robot of claim 23, wherein:
the mobile robot defines a height in a vertical dimension while the wheel and the plurality of additional wheels are in contact with the ground surface; and
a total mass of the mobile robot above the body-to-support connector along the height is greater than a total mass of the mobile robot below the body-to-support connector along the height.

25. The mobile robot of claim 24, wherein the body-to-support connector is at a lowermost third of the mobile robot along the height.

26. The mobile robot of claim 25, further comprising a fifth actuator configured to cause relative rotation between the body and the support about a fifth axis different from the third and fourth axes.

27. The mobile robot of claim 26, wherein the fifth axis is within 15 degrees of perpendicular to the fourth axis.

28. The mobile robot of claim 21, wherein:
the plurality of additional wheels includes three wheels configured to contact the ground surface; and
the wheel and the plurality of additional wheels are configured to define a rectangular support polygon of the mobile robot.

29. The mobile robot of claim 28, wherein:
the mobile robot further comprises an inertial measurement system at the body;
the controller is configured to receive orientation information from the inertial measurement system; and
the instructions, when executed via the processor, cause the mobile robot to maintain dynamic stability in the dynamically stable operational state via coordinated operation of at least the first actuator, the second actuator, the third actuator, and the fourth actuator based at least partially on the orientation information.

30. The mobile robot of claim 21, wherein the instructions, when executed via the processor, cause the mobile robot to operate the first actuator and the second actuator on a first timescale and to operate the third actuator and the fourth actuator on a second timescale different than the first timescale.

31. The mobile robot of claim 30, wherein the first timescale is faster than the second timescale.

32. A mobile robot comprising:
a first wheel configured to contact a horizontal ground surface at a first location while the mobile robot operates on the horizontal ground surface;
a second wheel configured to contact the horizontal ground surface at a second location different than the first location while the mobile robot operates on the horizontal ground surface;
a third wheel configured to contact the horizontal ground surface at a third location different than the first location and different than the second location while the mobile robot operates on the horizontal ground surface;
a support carried by the first wheel, the second wheel, and the third wheel;
a joint carried by the support;
a body connected to the support via the joint;
an arm carried by the body, wherein the mobile robot is configured to manipulate objects via the arm;
a first actuator configured to drive rotation of the first wheel relative to the support about a first axis;
a second actuator configured to drive rotation of the first wheel relative to the support about a second axis different than the first axis;
a third actuator configured to drive rotation of the body relative to the support via the joint; and
a controller including:
a processor, and
memory storing instructions that, when executed via the processor, cause the mobile robot to maintain dynamic stability via coordinated operation of the first actuator, the second actuator, and the third actuator.

33. The mobile robot of claim 32, wherein:
the joint is a first joint;
the third actuator is configured to drive rotation of the body relative to the support via the first joint about a third axis;
the mobile robot further comprises:
a second joint carried by the support, and
a fourth actuator configured to drive rotation of the body relative to the support via the second joint about a fourth axis different than the third axis; and
the body is connected to the support via the second joint.

34. The mobile robot of claim 33, wherein the fourth axis is within 15 degrees of perpendicular to the third axis.

35. The mobile robot of claim 32, wherein:
the mobile robot defines a height in a vertical dimension while the mobile robot operates on the horizontal ground surface; and
a total mass of the mobile robot above the joint along the height is greater than a total mass of the mobile robot below the joint along the height when the mobile robot operates on the horizontal ground surface.

36. The mobile robot of claim 35, wherein the joint is at a lowermost third of the mobile robot along the height when the mobile robot operates on the horizontal ground surface.

37. The mobile robot of claim 32, wherein the first axis is within 15 degrees of horizontal when the first wheel, the second wheel, and the third wheel are in contact with the horizontal ground surface.

38. The mobile robot of claim 37, wherein the second axis is within 15 degrees of perpendicular to the first axis.

39. The mobile robot of claim 38, wherein the second axis is within 15 degrees of horizontal when the first wheel, the second wheel, and the third wheel are in contact with the horizontal ground surface.

40. The mobile robot of claim 38, wherein the second axis is within 15 degrees of vertical when the first wheel, the second wheel, and the third wheel are in contact with the horizontal ground surface.

41-55. (canceled)
